(19) United States
(12) Patent Application Publication
(10) Pub. No.: US 2026/0014593 A1
(43) Pub. Date: Jan. 15, 2026

(54) SUBSTRATE PROCESSING APPARATUS

(71) Applicant: Samsung Electronics Co., Ltd., Suwon-si (KR)

(72) Inventors: Im Bi Yeo, Suwon-si (KR); Dong Hoon Kwon, Suwon-si (KR)

(21) Appl. No.: 19/019,833

(22) Filed: Jan. 14, 2025

(30) Foreign Application Priority Data
Jul. 10, 2024 (KR) 10-2024-0090831

(51) Int. Cl. B08B 1/12; B08B 1/40; B08B 1/52

(52) U.S. Cl. CPC B08B 1/12; B08B 1/40; B08B 1/52

(57) ABSTRACT

A substrate processing apparatus is provided. The substrate processing apparatus includes a chamber, a brush within the chamber, a driver configured to rotate the brush, an injector configured to inject a coating material onto a surface of the brush when the brush is rotated, a thickness adjuster configured to adjust a thickness of the coating material on the brush when the brush is rotated, and a curing device configured to cure the coating material having an adjusted thickness on the brush.

### CROSS-REFERENCE TO RELATED APPLICATION

This application claims priority 35 U.S.C. 119 from Korean Patent Application No. 10-2024-0090831, filed on Jul. 10, 2024, in the Korean Intellectual Property Office, the contents of which in its entirety are herein incorporated by reference.

### BACKGROUND

The present disclosure relates to a substrate processing apparatus.

During the manufacturing of a substrate, semiconductor elements are manufactured through many processes such as a deposition process, a polishing process, and an etching process. In addition, after the above-mentioned processes are performed, a cleaning process is performed to remove unnecessary foreign substances such as thin films and particles remaining on the substrate.

In particular, since many of these foreign substances remain on a surface of the substrate after a chemical mechanical polishing process (CMP) has been performed, a multi-step cleaning process needs to be performed to remove the remaining foreign substances. Therefore, methods are being sought to increase the removal efficiency of the foreign substances remaining on the surface of the substrate during the multi-step cleaning process.

Among the various cleaning methods, one method cleans the substrate using a brush that rotates and removes the foreign substances remaining on the surface of the substrate. However, these brushes need to be replaced when worn out. Thus, a method to increase the cleaning process efficiency by increasing the replacement cycle of these brushes may be desired.

### SUMMARY

Aspects of the present disclosure provide a substrate processing apparatus capable of increasing a replacement cycle of a brush.

According to an aspect of the present disclosure, a substrate processing apparatus is provided. The substrate processing apparatus includes a chamber, a brush within the chamber, a driver configured to rotate the brush, an injector configured to inject a coating material onto a surface of the brush when the brush is rotated, a thickness adjuster configured to adjust a thickness of the coating material on the brush when the brush is rotated, and a curing device configured to cure the coating material having an adjusted thickness on the brush.

According to an aspect of the present disclosure, a substrate processing apparatus is provided. The substrate processing apparatus includes a chamber including a first area, a second area, and a third area, the second area residing between the first area and the third area, a first brush within the chamber, a first driver configured to rotate the first brush and move the first brush between the first area and the second area, a second brush within the chamber, a second driver configured to rotate the second brush and move the second brush between the second area and the third area, and a first brush coating apparatus residing in the first area. The first brush coating apparatus includes a first injector configured to inject a first coating material onto a surface of the first brush when the first brush is rotated, a first thickness adjuster configured to adjust a thickness of the first coating material on the first brush when the first brush is rotated, and a first curing device configured to cure the first coating material having an adjusted thickness on the first brush. The chamber further includes a second brush coating apparatus residing in the third area, the second brush coating apparatus includes a second injector configured to inject a second coating material onto a surface of the second brush when the second brush is rotated, a second thickness adjuster configured to adjust a thickness of the second coating material on the second brush when the second brush is rotated, and a second curing device configured to cure the second coating material having an adjusted thickness on the second brush, and a controller configured to control the first driver, the second driver, the first brush coating apparatus, and the second brush coating apparatus.

According to an aspect of the present disclosure, a substrate processing apparatus is provided. The substrate processing apparatus includes a chamber, a brush within the chamber, a driver configured to rotate the brush, an injector configured to inject a coating material onto a surface of the brush when the brush is rotated, a thickness adjuster configured to adjust a thickness of the coating material on the brush when the brush is rotated, a curing device configured to cure the coating material having an adjusted thickness on the brush, a recovery tank residing below the brush and configured to recover the coating material injected onto the brush, a purifier connected to the recovery tank and configured to purify a recovered coating material, a contaminant discharge pipe connected to the purifier and configured to discharge contaminants filtered from the recovered coating material to an outside of the chamber, a supply pipe connected to the purifier and configured to re-supply the coating material purified by the purifier to the injector, a sensor positioned on an upper portion of the brush and configured to measure a thickness of the coating material cured on the brush, and a controller configured to receive information with respect to the thickness of the coating material from the sensor.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

### BRIEF DESCRIPTION OF THE DRAWINGS

FIG. 1 is a plan view illustrating a substrate processing apparatus according to some embodiments of the present disclosure.

FIG. 2 is a side view illustrating the substrate processing apparatus according to some embodiments of the present disclosure.

FIG. 3 is a side view illustrating the substrate processing apparatus according to some embodiments of the present disclosure.

FIG. 4 is a side view illustrating a nozzle of the substrate processing apparatus according to some embodiments of the present disclosure.

FIG. 5 is a plan view illustrating the nozzle of the substrate processing apparatus according to some embodiments of the present disclosure.

FIG. 6 is a perspective view illustrating a thickness adjuster of the substrate processing apparatus according to some embodiments of the present disclosure.

FIG. 7 and FIG. 8 are plan views illustrating a nozzle of a substrate processing apparatus according to another embodiment of the present disclosure.

FIG. 9 is a plan view illustrating a nozzle of the substrate processing apparatus according to another embodiment of the present disclosure.

FIG. 10 is a side view illustrating a nozzle of the substrate processing apparatus according to some embodiments of the present disclosure.

FIG. 11 is a plan view illustrating the nozzle of the substrate processing apparatus according to some embodiments of the present disclosure.

FIG. 12 is a perspective view illustrating a thickness adjuster of the substrate processing apparatus according to another embodiment of the present disclosure.

FIG. 13 is a perspective view illustrating a thickness adjuster of the substrate processing apparatus according to another embodiment of the present disclosure.

FIG. 14 is a schematic plan view illustrating a chemical mechanical polishing system according to some embodiments of the present disclosure.

FIG. 15 is a plan view illustrating a substrate processing apparatus according to another embodiment of the present disclosure.

FIG. 16 is a side view illustrating the substrate processing apparatus according to another embodiment of the present disclosure.

FIG. 17 is a plan view illustrating a substrate processing apparatus according to another embodiment of the present disclosure.

FIG. 18 is a side view illustrating the substrate processing apparatus according to another embodiment of the present disclosure.

FIG. 19 is a side view illustrating the substrate processing apparatus according to another embodiment of the present disclosure.

FIG. 20 is a plan view illustrating a substrate processing apparatus according to another embodiment of the present disclosure.

FIG. 21 is a side view illustrating the substrate processing apparatus according to another embodiment of the present disclosure.

FIG. 22 is a schematic plan view illustrating a chemical mechanical polishing system according to another embodiment of the present disclosure.

### DETAILED DESCRIPTION

Advantages and features of the present disclosure, and a method of achieving the advantages and features will become apparent with reference to embodiments described below in detail together with the accompanying drawings. However, the embodiments of the present disclosure are not limited to the example embodiments as disclosed herein, but may be implemented in various different forms. Thus, these embodiments are set forth only to make the present disclosure, and to inform the scope of the present disclosure to those of ordinary skill in the technical field to which the present disclosure belongs, and the present disclosure is only defined by the scope of the claims.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements may modify the entire list of elements and may not modify the individual elements of the list. In interpretation of numerical values, an error or tolerance therein may occur even when there is no explicit description thereof.

Spatially relative terms, such as “beneath,” “below,” “lower,” “under,” “above,” “upper,” and the like, may be used herein for ease of illustration to illustrate one element or feature's relationship to another element or feature as illustrated in the figures. It will be understood that the spatially relative terms are intended to encompass different orientations of the device in use or in operation, in addition to the orientation depicted in the figures. For example, when the device in the drawings may be turned over, elements described as “below” or “beneath” or “under” other elements or features would then be oriented “above” the other elements or features. Thus, the example terms “below” and “under” may encompass both an orientation of above and below. The device may be otherwise oriented, for example, rotated 90 degrees or at other orientations, and the spatially relative descriptors used herein should be interpreted accordingly.

It will be understood that, although the terms “first”, “second”, etc. may be used herein to describe various elements or components, these elements or components should not be limited by these terms. These terms are only used to distinguish one element or component from another element or component. Therefore, a first element or component mentioned below may also be a second element or component within the technical spirit of the present disclosure.

Hereinafter, example embodiments of the present disclosure will be explained in detail with reference to the accompanying drawings.

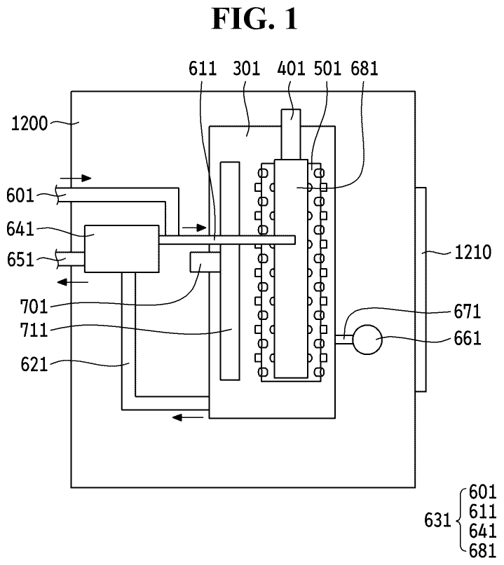

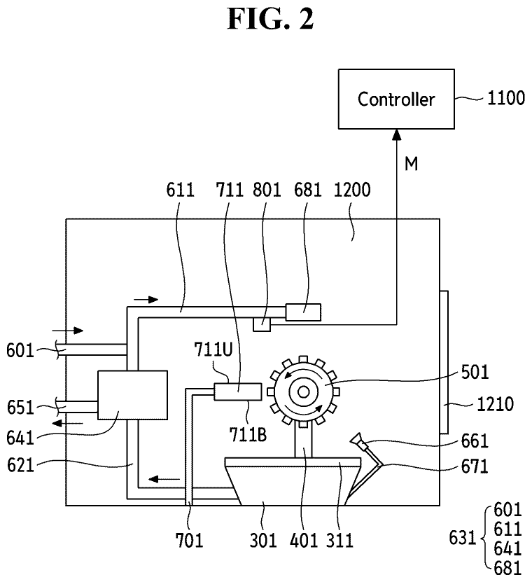

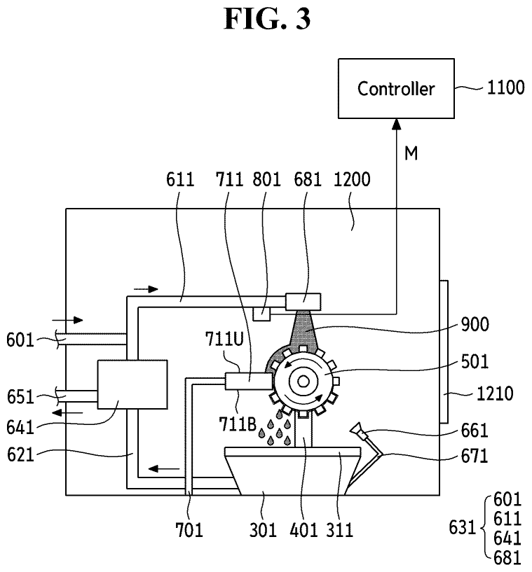

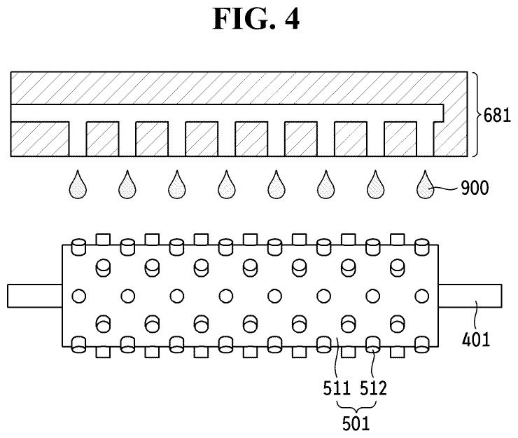

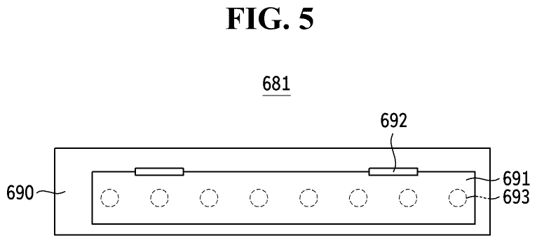

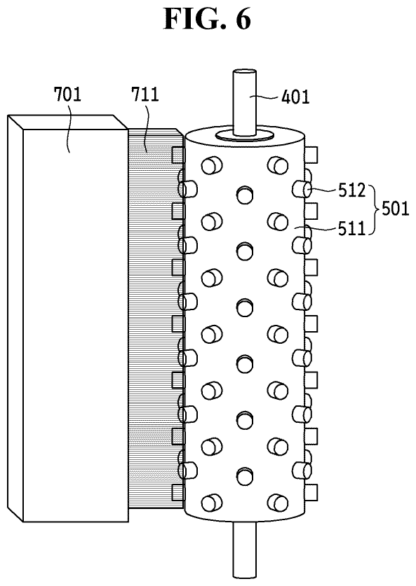

FIG. 1 is a plan view illustrating a substrate processing apparatus according to some embodiments of the present disclosure. FIG. 2 is a side view illustrating the substrate processing apparatus according to some embodiments of the present disclosure. FIG. 3 is a side view illustrating the substrate processing apparatus according to some embodiments of the present disclosure. FIG. 4 is a side view illustrating a nozzle of the substrate processing apparatus according to some embodiments of the present disclosure. FIG. 5 is a plan view illustrating the nozzle of the substrate processing apparatus according to some embodiments of the present disclosure. FIG. 6 is a perspective view illustrating a thickness adjuster of the substrate processing apparatus according to some embodiments of the present disclosure. For convenience of explanation, a shutter 311 is not shown in FIG. 1.

Referring to FIG. 1 to FIG. 5, a substrate processing apparatus according to some embodiments of the present disclosure may include a coating chamber 1200, a chamber door 1210, a brush 501, a brush driver 401, an injector 631, a thickness adjuster 711, a thickness adjuster support 701, a recovery tank 301, a recovery pipe 621, a curing device 661, a curing device support 671, a sensor 801, and a controller 1100.

A process of coating the brush 501 may be performed within the coating chamber 1200. In some embodiments, the coating chamber 1200 may be an apparatus for coating the brush 501 used in a process of cleaning a wafer after a chemical mechanical polishing (CMP) process is performed on the wafer.

The chamber door 1210 may be disposed on a side surface of the coating chamber 1200. The brush 501 may be inserted into or removed from the coating chamber 1200 through the chamber door 1210. The brush 501 may include a body portion 511 and a nodule 512. Each nodule 512 may be disposed on a surface of the body portion 511. For example, in some embodiments, each nodule 512 may have a protruding shape on the surface of the body portion 511. In some embodiments, the brush 501 may include, for example, polyvinyl alcohol (PVA).

The brush driver 401 may be disposed within the coating chamber 1200 and may be configured to rotate the brush 501 in a first direction (see FIG. 2 and FIG. 3). For example, in some embodiments, the brush driver 401 may rotate the brush 501 so that the brush 501 first contacts with an upper surface 711U of a thickness adjuster 711 (to be described later) and is then contacts a lower surface 711B of the thickness adjuster 711. For example, as illustrated in FIG. 2, in some embodiments, the brush driver 401 may rotate the brush 501 in a counterclockwise direction, but the example embodiment of the present disclosure is not limited thereto. In other embodiments, the brush driver 401 may rotate the brush 501 in a clockwise direction.

The injector 631 may be disposed within the coating chamber 1200. For example, in some embodiments, the injector 631 may be disposed at an upper portion of the coating chamber 1200. In some embodiments, the injector 631 may include a nozzle 681, a coating material supply pipe 601, a nozzle supply pipe 611, and a purifier 641. The injector 631 may be configured to inject a coating material 900 toward the brush 501 inserted into the coating chamber 1200. In some embodiments, the nozzle 681 of the injector 631 may be positioned above the brush 501.

In some embodiments, the coating material 900 may be a polymer solution in a liquid state. The coating material 900 may include, for example, at least one of a phenolic resin, an epoxy resin, a melamine resin, a silicone resin, a urethane resin, a polyester resin, and a polyamide resin, but the example embodiment of the present disclosure is not limited thereto. In some embodiments, the coating material 900 may be a pure coating material, a reused coating material or a combination thereof. For reference, in some embodiments, the pure coating material may mean a non-reused coating material.

As shown in FIG. 5, in some embodiments, the nozzle 681 of the injector 631 may include a main body portion 690, an injection hole 693, a cover portion 691, and a cover joint portion 692. The main body portion 690 may be connected to the nozzle supply pipe 611 to provide the coating material 900 to the nozzle 681. In some embodiments, the number of injection holes 693 may be plural. For example, in some embodiments, the injection hole 693 may include a plurality of circular holes arranged in a row. In some embodiments, the coating material 900 may be provided onto the brush 501 through the one or more injection holes 693 of the nozzle 681 of the injector 631.

The cover portion 691 may be disposed on a surface of the main body portion 690 of the nozzle 681. The cover portion 691 may cover the injection hole 693 when the coating material 900 is not being provided from the nozzle 681. The cover portion 691 may cover the injection hole 693, thereby preventing foreign substances from entering or from forming in the injection hole 693. That is, the cover portion 691 may prevent contamination of the injector 631 by preventing the injection hole 693 from being exposed (i.e. open) while the coating material 900 is not being provided from the nozzle 681. The cover joint portion 692 may enable the cover portion 691 to be connected to the main body portion 690 of the nozzle 681. For example, in some embodiments, the cover joint portion 692 may enable the cover portion 691 to be connected to the main body portion 690 in hinged manner.

The coating material supply pipe 601 may supply the coating material 900 to the nozzle 681. The coating material supply pipe 601 may be connected to the nozzle supply pipe 611 to be described later. The coating material supply pipe 601 may be connected to a coating material storage tank (not illustrated) and may provide the coating material 900 to the nozzle 681.

In some embodiments, the nozzle supply pipe 611 may supply the coating material 900 to the nozzle 681. The nozzle supply pipe 611 may supply both the re-used coating material 900 and the pure coating material 900 to the nozzle 681. For example, in some embodiments, the re-used coating material 900 and the pure coating material 900 may be mixed and provided to the nozzle supply pipe 611. In some embodiments, the purifier 641 that is configured to purify the reused coating material 900 will be described together with the recovery tank 301 and recovery pipe 621.

The thickness adjuster 711 may be disposed within the coating chamber 1200 and is configured to adjust the coating material 900 provided on the surface of the brush 501 such that the coating material 900 is uniformly applied. The thickness adjuster 711 may be fixed by the thickness adjuster support 701. For example, in some embodiments, the thickness adjuster 711 may be positioned at the same height as the brush 501. The thickness adjuster 711 may include an upper surface 711U and a lower surface 711B that are opposed to each other. For example, the upper surface 711U of the thickness adjuster 711 may be in contact with the brush 501 before the lower surface 711B contacts the brush 501.

In some embodiments, the thickness adjuster 711 may include a brush shape. The thickness adjuster 711 having the brush shape may be in direct contact with the brush 501 to adjust the coating material 900 provided to the brush 501 such that the coating material 900 is uniformly applied. The thickness adjuster 711 may cause the coating material 900 to be applied to each nodule 512 of the brush 501. The coating material 900 may be applied to each nodule 512 of the brush without exception by the thickness adjuster 711. While the brush 501 rotates in one direction by the brush driver 401, the thickness adjuster 711 fixed within the coating chamber 1200 may adjust the coating material 900 provided to the brush 501 to be uniformly applied thereon.

The recovery tank 301 may recover the coating material 900 that is not applied to the brush 501 among the coating material 900 injected from the injector 631 toward the brush 501. The recovery tank 301 may include a shutter 311. The shutter 311 of the recovery tank 301 may be opened before the injector 631 injects the coating material 900, and closed after the injector 631 stops injection of the coating material 900. The shutter 311 of the recovery tank 301 may prevent contaminants from entering the recovery tank 301.

The recovery tank 301 may be connected to the recovery pipe 621. The coating material 900 recovered in the recovery tank 301 may be connected to the purifier 641 through the recovery pipe 621. The purifier 641 may be configured to purify the recovered coating material 900. For example, in some embodiments, the purifier 641 may include a filter. In this case, the filter included in the purifier 641 may remove contaminants from the recovered coating material 900. The contaminants filtered from the coating material 900 may be discharged to an outside of the coating chamber 1200 through a contaminant discharge pipe 651. The coating material 900 purified from the purifier 641 may be re-supplied to the nozzle 681 through the nozzle supply pipe 611. Since the coating material 900 is reused by the purifier 641, the cost of the process of coating the brush 501 may be reduced.

The curing device 661 may be disposed within the coating chamber 1200 and may be configured to cure the coating material 900 applied to the brush 501. In some embodiments, the curing device 661 may be fixed within the coating chamber 1200 by the curing device support 671. In some embodiments, the curing device 661 may be positioned below the brush 501 by the curing device support 671.

In some embodiments, the curing device 661 may be configured to cure the coating material 900, for example, by a method of applying heat to the brush 501 to which the coating material 900 has been applied. For example, when the coating material 900 is a phenolic resin in a liquid state, the curing device 661 may cure the phenolic resin applied to the brush 501 by applying heat of about 130° C. or higher to about 160° C. to the brush 501. The phenolic resin applied to the brush 501 becomes cured, thereby coating the brush 501 with the phenolic resin.

As another example, in some embodiments, the curing device 661 may cure the coating material 900 by a method of applying light to the brush 501. In some embodiments, the curing device 661 may cure the coating material 900 by applying light such as ultraviolet rays (UV) or electron rays to the brush 501. For example, when the coating material 900 is an epoxy resin in a liquid state, the curing device 661 may cure the epoxy resin applied to the brush 501 by applying ultraviolet rays (UV) to the brush 501. The epoxy resin applied to the brush 501 becomes cured, thereby coating the brush 501 with the epoxy resin.

While the brush 501 rotates in the first direction (e.g., counterclockwise direction) by the brush driver 401, the curing device 661 fixed within the coating chamber 1200 may cure the coating material 900 provided to the brush 501. For example, in some embodiments, the coating material 900 may be provided to the brush 501 by the injector 631, the coating material 900 provided to the brush 501 may be uniformly applied by the thickness adjuster 711, and the coating material 900 uniformly applied to the brush 501 may be cured by the curing device 661.

The sensor 801 may be disposed within the coating chamber 1200 and may be configured to detect a thickness of the coating material 900 cured on the brush 501. The sensor 801 may operate while no coating material 900 is being provided from the injector 631 toward the brush 501. Information M with respect to the thickness of the coating material 900 measured by the sensor 801 may be transmitted to the controller 1100.

In some embodiments, the sensor 801 may be, for example, an optical sensor. When the sensor 801 is the optical sensor, the sensor 801 may be configured to detect the thickness of the coating material 900 cured on the brush 501 by applying light to the brush 501. As another example, in some embodiments, the sensor 801 may be an ultrasonic sensor. When the sensor 801 is the ultrasonic sensor, the sensor 801 may be configured to detect the thickness of the coating material 900 cured on the brush 501 by generating ultrasonic waves toward the brush 501.

The sensor 801 may be configured to measure the thickness and uniformity of the coating material 900 cured on the brush 501, but the example embodiment of the present disclosure is not limited thereto. As another example, in some embodiments, the sensor 801 may also be configured to detect other characteristics of the coating material 900 cured on the brush 501.

In some embodiments, the controller 1100 may be configured to receive the information M with respect to the thickness of the coating material 900 cured on the brush 501 from the sensor 801. In some embodiments, the controller 1100 may be configured to control factors such as the contact pressure between the brush 501 and the substrate and the rotation speed of the brush 501 while the substrate cleaning process is performed by the brush 501, by analyzing the received information M on the thickness of the coating material 900. For example, in some embodiments, when the thickness of the coating material 900 cured on the brush 501 becomes thinner, the controller 1100 may control the pressure applied by the brush 501 to the substrate to gradually increase during the process of cleaning the substrate. As another example, in some embodiments, when the thickness of the coating material 900 cured on the brush 501 is not uniform, the controller 1100 may control the pressure that each portion of the brush 501 applies to the substrate.

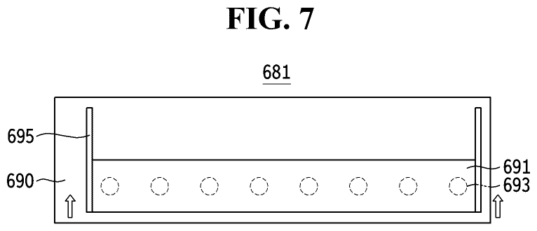

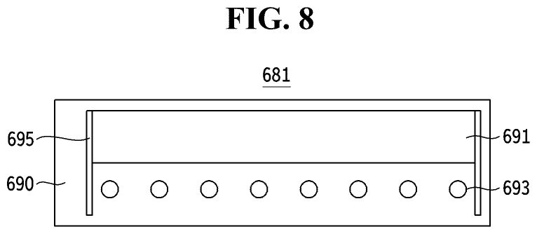

FIG. 7 and FIG. 8 are plan views illustrating a nozzle 681 of a substrate processing apparatus according to another embodiment of the present disclosure. For convenience of explanation, the description of FIG. 7 and FIG. 8 will primarily be directed to the differences of the nozzle 681 from those previously described with reference to FIG. 1 to FIG. 6. For reference, FIG. 7 is a view illustrating when the cover portion 691 covers the injection hole(s) 693, and FIG. 8 is a view illustrating when the cover portion 691 exposes the injection hole(s) 693 (i.e., does not cover the injection hole 693).

Referring to FIG. 7 and FIG. 8, in some embodiments, the nozzle 681 may include a main body portion 690, an injection hole 693, a cover portion 691, and a cover rail 695. The cover rail 695 may be disposed on a surface of the nozzle 681. The cover portion 691 may be configured to move along the cover rail 695. The cover portion 691 may move along the cover rail 695 to cover or expose the injection hole 693. The cover portion 691 may cover the injection hole 693 while the coating material 900 is not being provided from the nozzle 681. The cover portion 691 may cover the injection hole 693, thereby preventing foreign substances from entering into and/or forming in the injection hole 693. That is, the cover portion 691 may prevent contamination by preventing the injection hole 693 from being exposed while the coating material 900 is not being provided from the nozzle 681.

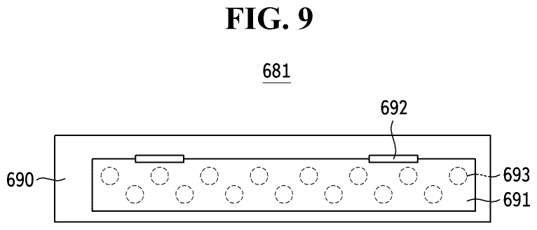

FIG. 9 is a plan view illustrating a nozzle 681 of the substrate processing apparatus according to another embodiment of the present disclosure. For convenience of explanation, the description of FIG. 9 will primarily be directed to the differences of the nozzle 681 from those previously described with reference to FIG. 1 to FIG. 6. For reference, the nozzle 681 illustrated in FIG. 9 may correspond to the nozzle 681 illustrated in FIG. 1 to FIG. 3.

Referring to FIG. 9, in some embodiments, the nozzle 681 may include a main body portion 690, an injection hole 693, a cover portion 691, and a cover joint portion 692. The main body portion 690 may be connected to the nozzle supply pipe 611 to provide the coating material 900 to the nozzle 681. In some embodiments, the number of injection holes 693 may be plural. For example, in some embodiments, the injection hole 693 may include a plurality of circular holes arranged in two rows, but the example embodiment of the present disclosure is not limited thereto. As another example, in some embodiments, the injection hole 693 may also include a plurality of circular holes arranged in three or more rows, or may also include a plurality of circular holes arranged randomly without any rules.

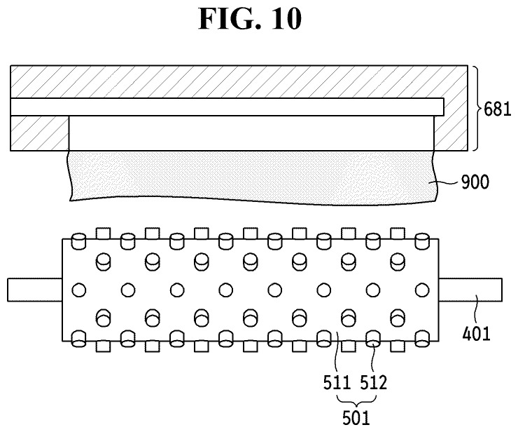

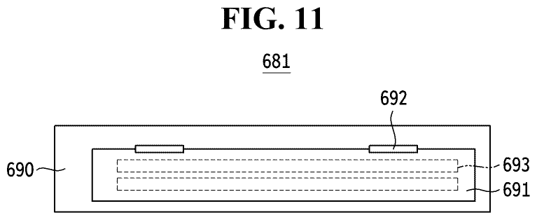

FIG. 10 is a side view illustrating a nozzle 681 of the substrate processing apparatus according to some embodiments of the present disclosure. FIG. 11 is a plan view illustrating the nozzle 681 of the substrate processing apparatus according to some embodiments of the present disclosure. For convenience of explanation, the description of FIG. 10 and FIG. 11 will primarily be directed to the differences of the nozzle 681 from those previously described with reference to FIG. 1 to FIG. 6. For reference, in some embodiments, the nozzle 681 illustrated in FIG. 10 and FIG. 11 may correspond to the nozzle 681 illustrated in FIG. 1 to FIG. 3.

Referring to FIG. 10 and FIG. 11, in some embodiments, the nozzle 681 may include a main body portion 690, an injection hole 693, a cover portion 691, and a cover joint portion 692. The main body portion 690 may be connected to the nozzle supply pipe 611 to provide the coating material 900 to the nozzle 681. In some embodiments, the number of injection holes 693 may be plural. For example, in some embodiments, the injection hole 693 may include a line-shaped hole in the form of a straight line. As the injection hole 693 includes the line-shaped hole, the injection hole 693 may be provided in a form that allows the coating material 900, 900′ to flow onto the surface of the brush 501. When the injection hole 693 includes the line-shaped hole, the coating material 900 may be sufficiently provided onto the brush 501. Accordingly, the time required to provide the coating material 900 to the surface of the brush 501 may be reduced, thereby increasing process efficiency.

In some embodiments, the cover portion 691 may be disposed on a surface of the main body portion 690 of the nozzle 681. The cover portion 691 may cover the injection hole 693 while the coating material 900 is not being provided from the nozzle 681. The cover portion 691 may cover the injection hole 693, thereby preventing foreign substances from entering into and/or forming in the injection hole 693. That is, the cover portion 691 may help to prevent contamination by preventing the injection hole 693 from being exposed when the coating material 900 is not being provided from the nozzle 681. In some embodiments, the cover joint portion 692 may enable the cover portion 691 to be connected to the main body portion 690. For example, in some embodiments, the cover joint portion 692 may enable the cover portion 691 to be connected to the main body portion 690 in a hinged manner.

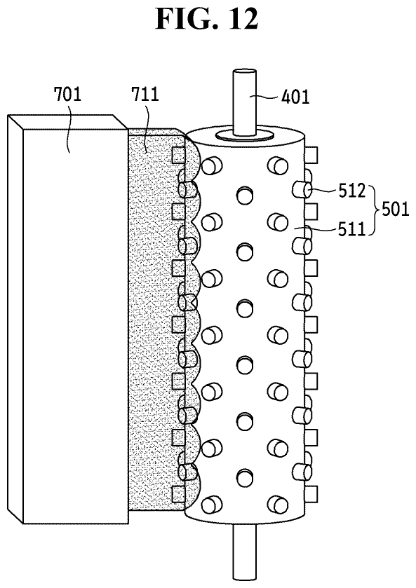

FIG. 12 is a perspective view illustrating a thickness adjuster 711 of the substrate processing apparatus according to another embodiment of the present disclosure. For convenience of explanation, the description of FIG. 12 primarily is directed to the differences of the thickness adjuster 711 from those previously described with reference to FIG. 1 to FIG. 6. For reference, in some embodiments, the thickness adjuster 711 illustrated in FIG. 12 may correspond to the thickness adjuster 711 illustrated in FIG. 1 to FIG. 3.

Referring to FIG. 12, in some embodiments, the thickness adjuster 711 may include a sponge-like shape. The thickness adjuster 711 of the sponge-like shape may be in direct contact with the brush 501 to adjust the coating material 900 provided to the brush 501 such that the coating material 900 may be uniformly applied. In some embodiments, the thickness adjuster 711 may cause the coating material 900 to be applied to each nodule 512 of the brush 501. In some embodiments, the coating material 900 may be applied to each nodule 512 of the brush 501 without exception by the thickness adjuster 711 (i.e., the thickness adjuster 711 helps to ensure that the coating material 900 is applied to every nodule 512 of the brush 501). As the brush 501 rotates in the first direction (e.g., counterclockwise) by the brush driver 401, the thickness adjuster 711 fixed within the coating chamber 1200 may adjust the coating material 900 provided to the brush 501 such that the coating material 900 is uniformly applied.

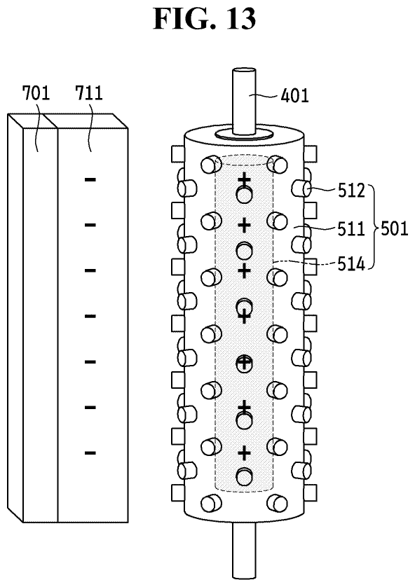

FIG. 13 is a perspective view illustrating a thickness adjuster 711 of the substrate processing apparatus according to another embodiment of the present disclosure. For convenience of explanation, the description of FIG. 13 primarily is directed to the differences of the thickness adjuster 711 from those previously described with reference to FIG. 1 to FIG. 6. For reference, in some embodiments, the thickness adjuster 711 illustrated in FIG. 13 may correspond to the thickness adjuster 711 illustrated in FIG. 1 to FIG. 3.

Referring to FIG. 13, in some embodiments, a magnetic body 514 having a first electrode (+) may be disposed at a general central portion of the brush 501 (e.g., inside the brush 501). In some embodiments, the thickness adjuster 711 may have a second electrode (−) that is different from the first electrode (+). For example, in some embodiments, the first electrode (+) of the magnetic body 514 disposed inside the brush 501 may be a cathode, and the second electrode (−) of the thickness adjuster 711 may be an anode.

The coating material (e.g., coating material 900 in FIG. 3) may include magnetic particles. The coating material 900 may have an attractive force on the first electrode (+) and a repulsive force on the second electrode (−). In some embodiments, when the coating material 900 is provided on the surface of the brush 501 by the attractive force of the magnetic body 514, the thickness of the coating material 900 provided on the surface of the brush 501 may be adjusted by the repulsive force of the thickness adjuster 711.

In some embodiments, the thickness adjuster 711 having the second electrode (−) may not be in direct contact with the brush 501 in order to adjust the coating material 900 provided on the brush 501 to be uniformly applied. In some embodiments, the thickness adjuster 711 may cause the coating material 900 to be applied to each nodule 512 of the brush 501. The coating material 900 may be applied to each nodule 512 of the brush without exception by the thickness adjuster 711 (i.e., the thickness adjuster 711 helps to ensure that the coating material 900 is applied to every nodule 512 of the brush 501). As the brush 501 rotates in the first direction (e.g., counterclockwise) by the brush driver 401, the thickness adjuster 711 fixed within the coating chamber 1200 may adjust the coating material 900 provided on the brush 501 such that the coating material 900 is uniformly applied.

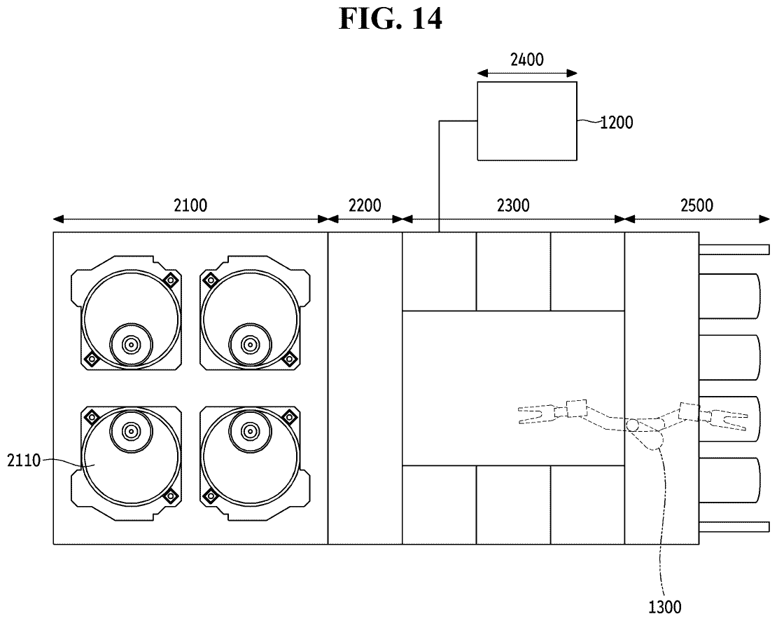

FIG. 14 is a schematic plan view illustrating a chemical mechanical polishing system according to some embodiments of the present disclosure.

Referring to FIG. 14, a chemical mechanical polishing system according to some embodiments of the present disclosure may include a polishing part 2100, a transport part 2200, a cleaning part 2300, a brush coating part 2400, a robot arm 1300, and a cassette unit 2500.

The polishing part 2100 may be provided with various structures capable of performing a chemical mechanical polishing process, and the present disclosure is not limited or restricted by the structure and layout of the polishing part 2100. The polishing part 2100 may also be provided with a carrier apparatus (not illustrated) that transports a substrate entering the polishing part 2100 to a polishing plate 2110.

The polishing part 2100 may be provided with a plurality of polishing plates 2110, and a polishing pad (not illustrated) may be attached to an upper surface of each polishing plate 2110. The chemical mechanical polishing process may be performed on a substrate provided inside the polishing part 2100. For example, in some embodiments, the polishing plate 2110 may rotate and polish the surface of the substrate. The carrier apparatus (not illustrated) may be disposed in the transport part 2200 to load a substrate on which the chemical mechanical polishing process has been performed into the cleaning part 2300.

In the cleaning part 2300, a substrate cleaning process for removing organic substances and other foreign substances remaining on the surface of the substrate may be performed. For example, the brush (see, e.g., brush 501 in FIG. 1) that is in physical contact with the surface of the substrate and performs cleaning may be disposed in the cleaning part 2300. As another example, in some embodiments, the brush 501 that performs cleaning without being in direct contact with the surface of the substrate may be disposed in the cleaning part 2300. The brush 501 disposed within the cleaning part 2300 may rotate in the first direction (e.g., counterclockwise) and remove the foreign substances remaining on the surface of the substrate.

The brush coating part 2400 may be configured as a separate chamber from the polishing part 2100, the transport part 2200, the cleaning part 2300, and the cassette unit 2500. In the brush coating part 2400, a process of coating the brush 501 used in the cleaning part 2300 may be performed. When it is determined that coating is necessary due to wear of the brush 501 (for example, while using the brush 501 in the cleaning part 2300), the controller (see, e.g., the controller 1100 in FIG. 2) may control the brush 501 to be transferred from the cleaning part 2300 to the brush coating part 2400. In some embodiments, the controller 1100 may also control the brush 501 whose coating has been completed to be transferred from the brush coating part 2400 back to the cleaning part 2300.

In some embodiments, the coating chamber 1200 of the brush coating part 2400 may correspond to the coating chamber 1200 of FIG. 2, and described herein. That is, the brush coating part 2400 may include a coating chamber (see, e.g., coating chamber 1200 in FIG. 2), a chamber door (see, e.g., chamber door 1210 in FIG. 2), a brush 501, a brush driver (see, e.g., brush driver 401 in FIG. 2), an injector (see, e.g., injector 631 in FIG. 2), a thickness adjuster (see, e.g., thickness adjuster 711 in FIG. 2), a thickness adjuster support (see, e.g., thickness adjuster support 701 in FIG. 2), a recovery tank (see, e.g., recovery tank 301 in FIG. 2), a recovery pipe (see, e.g., recovery pipe 621 in FIG. 2), a curing device (see, e.g., curing device 661 in FIG. 2), a curing device support (see, e.g., curing device support 671 in FIG. 2), a sensor (see, e.g., sensor 801 in FIG. 2), and a controller (see, e.g., controller 1100 in FIG. 2).

In some embodiments, the robot arm 1300 may be disposed within the coating chamber 1200 and may be configured to transfer a substrate that has been cleaned in the cleaning part 2300 to the cassette unit 2500. Although not illustrated, in some embodiments, the robot arm may also be disposed between the transport part 2200 and the cleaning part 2300.

In some embodiments, the cassette unit 2500 may be configured to store the substrate. In some embodiments, the cassette unit 2500 may be configured to store substrates by transporting the substrates to various process modules that process the substrates or by bringing in substrates on which the processes have been performed. In some embodiments, the cassette unit 2500 may be, for example, an Equipment Front-End Module (EFEM).

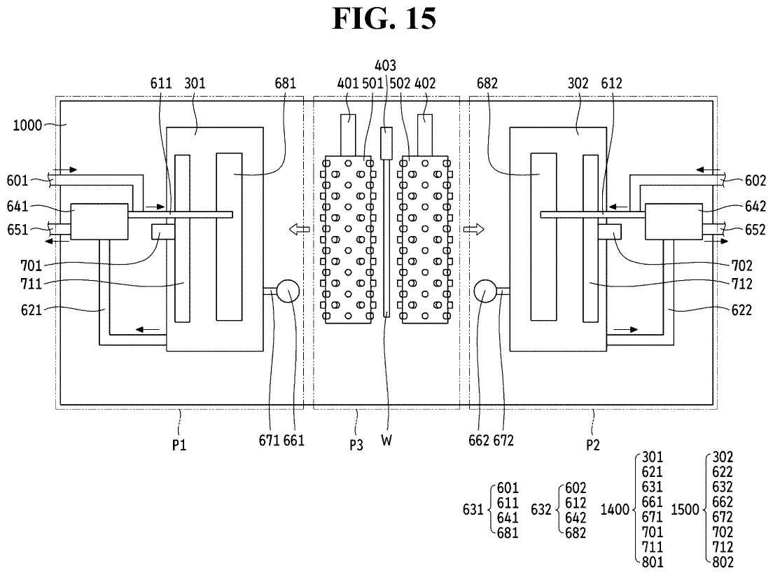

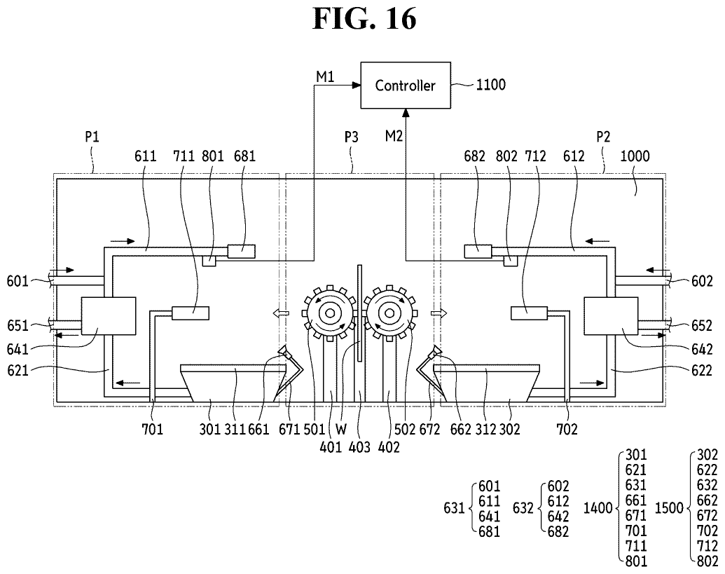

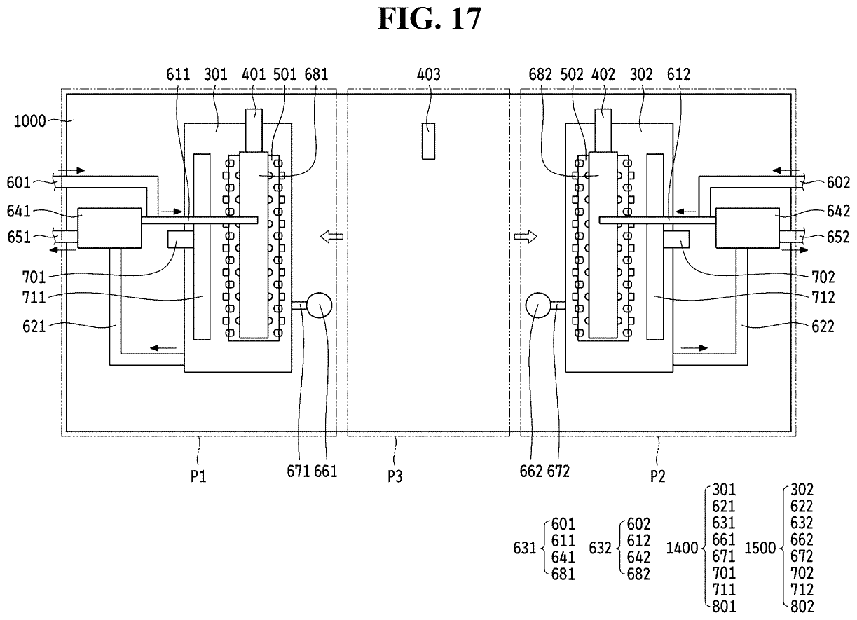

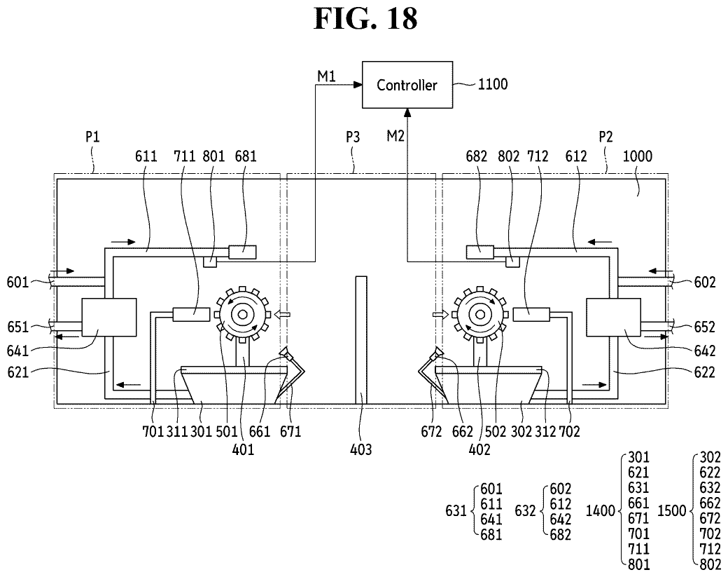

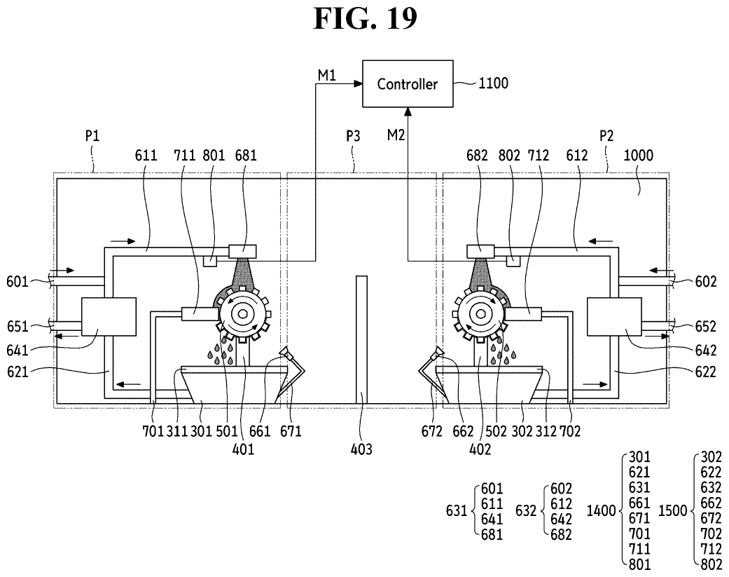

FIG. 15 is a plan view illustrating a substrate processing apparatus according to another embodiment of the present disclosure. FIG. 16 is a side view illustrating the substrate processing apparatus according to another embodiment of the present disclosure. FIG. 17 is a plan view illustrating a substrate processing apparatus according to another embodiment of the present disclosure. FIG. 18 is a side view illustrating the substrate processing apparatus according to another embodiment of the present disclosure. FIG. 19 is a side view illustrating the substrate processing apparatus according to another embodiment of the present disclosure. For reference, FIG. 17 and FIG. 18 are views illustrating a state in which a first brush 501 and a second brush 502 of FIG. 15 and FIG. 16 move toward a first area P1 and a second area P2, respectively, and FIG. 19 is a view illustrating a state in which the coating material 900 is injected onto the first brush 501 and the second brush 502 of FIG. 17 and FIG. 18. For convenience of explanation, the description of FIG. 15 and FIG. 16 primarily is directed to the differences of the present disclosure from those previously described with reference to FIG. 1 to FIG. 6. For convenience of explanation, a first shutter 311 and a second shutter 312 is not shown in FIGS. 15 and 17.

Referring to FIG. 15 and FIG. 16, in some embodiments, a substrate processing apparatus according to another embodiment of the present disclosure may include a controller 1100 and a first area P1, a third area P3, and a second area P2 sequentially disposed within a chamber 1000. In other words, in some embodiments, the third area P3 may be disposed between the first area P1 and the second area P2.

In some embodiments, a first brush coating apparatus 1400 may be disposed in the first area P1 of the chamber 1000. The first brush coating apparatus 1400 may include a first injector 631, a first thickness adjuster 711, a first thickness adjuster support 701, a first recovery tank 301, a first recovery pipe 621, a first curing device 661, a first curing device support 671, and a first sensor 801.

In some embodiments, a second brush coating apparatus 1500 may be disposed in the second area P2 of the chamber 1000. The second brush coating apparatus 1500 may include a second injector 632, a second thickness adjuster 712, a second thickness adjuster support 702, a second recovery tank 302, a second recovery pipe 622, a second curing device 662, a second curing device support 672, and a second sensor 802.

The first area P1 and the second area P2 may include the same configuration, but the example embodiment of the present disclosure is not limited thereto. As another example, in some embodiments, the first area P1 of the chamber 1000 may additionally include different components from the second area P2.

In some embodiments, a substrate W, a substrate support 403, a first brush 501, a first brush driver 401, a second brush 502, and a second brush driver 402 may be disposed in the third area P3 of the chamber 1000. In some embodiments, in the third area P3 of the chamber 1000, a substrate cleaning process for removing organic substances and other foreign substances remaining on the surface of the substrate may be performed.

The first injector 631 and the second injector 632 may have substantially the same configuration as the injector 631 illustrated in FIG. 1 to FIG. 3. The first thickness adjuster 711 and the second thickness adjuster 712 may have substantially the same configuration as the thickness adjuster 711 illustrated in FIG. 1 to FIG. 3. The first recovery tank 301 and the second recovery tank 302 may have substantially the same configuration as the recovery tank 301 illustrated in FIG. 1 to FIG. 3. The first recovery pipe 621 and the second recovery pipe 622 may have substantially the same configuration as the recovery pipe 621 illustrated in FIG. 1 to FIG. 3. The first curing device 661 and the second curing device 662 may have substantially the same configuration as the curing device 661 illustrated in FIG. 1 to FIG. 3. The first curing device support 671 and the second curing device support 672 may have substantially the same configuration as the curing device support 671 illustrated in FIG. 1 to FIG. 3. The first sensor 801 and the second sensor 802 may have substantially the same configuration as the sensor 801 illustrated in FIG. 1 to FIG. 3.

In some embodiments, the first injector 631 may include a first nozzle 681, a first coating material supply pipe 601, a first nozzle supply pipe 611, and a first purifier 641. The first injector 631 may be configured to inject the coating material 900 toward the first brush 501. The first nozzle 681 may be positioned above the first brush 501.

The first coating material supply pipe 601 may supply a coating material 900 to the first nozzle 681. For reference, in some embodiments, the first coating material supply pipe 601 may be connected to the first nozzle supply pipe 611. The first coating material supply pipe 601 may be connected to a first coating material storage tank (not illustrated) and may be configured to provide the coating material 900 to the first nozzle 681.

The first thickness adjuster 711 may be configured to adjust the coating material 900 provided on the surface of the first brush 501 such that the coating material 900 is uniformly applied. The first thickness adjuster 711 may be fixed by the first thickness adjuster support 701. For example, in some embodiments, the first thickness adjuster 711 may be positioned at the same height as the first brush 501.

The first recovery tank 301 may be configured to recover the coating material 900 that is not applied to the first brush 501 among the coating material 900 that is injected from the first injector 631 toward the first brush 501. In some embodiments, the first recovery tank 301 may be connected to the first recovery pipe 621. In some embodiments, the coating material 900 recovered in the first recovery tank 301 may be flow to the first purifier 641 through the first recovery pipe 621. The first purifier 641 may be configured to purify the recovered coating material 900. The contaminants filtered from the coating material 900 by the first purifier 641 may be discharged to the outside of the chamber 1000 through the first contaminant discharge pipe 651. The coating material 900 purified from the first purifier 641 may be re-supplied to the first nozzle 681 through the first nozzle supply pipe 611.

In some embodiments, the first curing device 661 may be disposed within the first coating chamber 1200 and may be configured to cure the coating material 900 applied to the first brush 501. In some embodiments, the first curing device 661 may be fixed within the first coating chamber 1200 by the first curing device support 671. In some embodiments, the first curing device 661 may be positioned below the first brush 501 by the first curing device support 671. As the first brush 501 rotates in the first direction (e.g., counterclockwise) by the first brush driver 401, the first curing device 661 may cure the coating material 900 provided to the first brush 501.

In some embodiments, the first sensor 801 may be configured to measure a thickness of the coating material 900 cured on the first brush 501. In some embodiments, the first sensor 801 may operate while no coating material 900 is being provided from the first injector 631 toward the first brush 501. In some embodiments, information M1 with respect to the thickness of the coating material 900 measured by the first sensor 801 may be transmitted to the controller 1100.

In some embodiments, the second injector 632 may include a second nozzle 682, a second coating material supply pipe 602, a second nozzle supply pipe 612, and a second purifier 642. The second injector 632 may be configured to inject the coating material 900 toward the second brush 502. In some embodiments, the second nozzle 682 may be positioned above the second brush 502.

In some embodiments, the second coating material supply pipe 602 may supply the coating material 900 to the second nozzle 682. For reference, in some embodiments, the second coating material supply pipe 602 may be connected to the second nozzle supply pipe 612. In some embodiments, the second coating material supply pipe 602 may be connected to a second coating material storage tank (not illustrated) and may be configured to provide the coating material 900 to the second nozzle 682.

In some embodiments, the second thickness adjuster 712 may be configured to adjust the coating material 900 provided on the surface of the second brush 502 such that the coating material 900 is uniformly applied. The second thickness adjuster 712 may be fixed by the second thickness adjuster support 702. For example, in some embodiments, the second thickness adjuster 712 may be positioned at the same height as the second brush 502.

In some embodiments, the second recovery tank 302 may be configured to recover the coating material 900 that is not applied to the second brush 502 among the coating material 900 that is injected from the second injector 632 toward the second brush 502. In some embodiments, the second recovery tank 302 may be connected to the second recovery pipe 622. In some embodiments, the coating material 900 recovered in the second recovery tank 302 may flow to the second purifier 642 through the second recovery pipe 622. In some embodiments, the second purifier 642 may be configured to purify the recovered coating material 900. The contaminants filtered from the coating material 900 by the second purifier 642 may be discharged to the outside of the chamber 1000 through the second contaminant discharge pipe 652. The coating material 900 purified from the second purifier 642 may be re-supplied to the second nozzle 682 through the second nozzle supply pipe 612.

In some embodiments, the second curing device 662 may be disposed within the second coating chamber 1200 and may be configured to cure the coating material 900 applied to the second brush 502. The second curing device 662 may be fixed by the second curing device support 672. In some embodiments, the second curing device 662 may be positioned below the second brush 502 by the second curing device support 672. As the second brush 502 rotates in the first direction (e.g., counterclockwise) by the second brush driver 402, the second curing device 662 may cure the coating material 900 provided to the second brush 502.

In some embodiments, the second sensor 802 may be configured to measure a thickness of the coating material 900 cured on the second brush 502. In some embodiments, the second sensor 802 may operate while no coating material 900 is being provided from the second injector 632 toward the second brush 502. In some embodiments, information M2 with respect to the thickness of the coating material 900 measured by the second sensor 802 may be transmitted to the controller 1100.

In some embodiments, the first brush 501 and the second brush 502 may have substantially the same configuration as the brush 501 illustrated in FIG. 1 to FIG. 3. In some embodiments, the first brush driver 401 and the second brush driver 402 may have substantially the same configuration as the brush driver 401 illustrated in FIG. 1 to FIG. 3.

In some embodiments, the substrate support 403 may be disposed between the first brush driver 401 and the second brush driver 402. The substrate W may be fixed by the substrate support 403, but the example embodiment of the present disclosure is not limited thereto. As another example, in some embodiments, the substrate support 403 may be configured to support and rotate the substrate W.

In some embodiments, the substrate W may be disposed between the first brush 501 and the second brush 502 by the substrate support 403. In some embodiments, the substrate W is disposed between the first brush 501 and the second brush 502 so that a substrate cleaning process may be performed thereon. In some embodiments, the first brush 501 may rotate in a first direction by the first brush driver 401. In some embodiments, the second brush 502 may rotate in a second direction by the second brush driver 402. In some embodiments, the first brush 501 and the second brush 502 may rotate in opposite directions. For example, in some embodiments, the first brush 501 may rotate in a counterclockwise direction and the second brush may rotate in a clockwise direction, or vice versa.

In some embodiments, the first brush 501 and the second brush 502 may each come into contact with the substrate W to remove foreign substances remaining on the surface of the substrate W. As another example, in some embodiments, the first brush 501 and the second brush 502 may also remove foreign substances remaining on the surface of the substrate W without coming into direct contact with the substrate W.

In some embodiments, the controller 1100 may be configured to receive the information M1 and M2 with respect to the thicknesses of the coating material 900 cured on the first brush 501 and the second brush 502 from the first sensor 801 and the second sensor 802, respectively. The controller 1100 may be configured to control factors such as the contact pressure between the first brush 501 and the second brush 502 and the substrate W and the rotation speed of the first brush 501 and the second brush 502 while the substrate cleaning process is performed within the third area P3, for example, by analyzing the received information M1 and M2 with respect to the thickness of the coating material 900 on the first brush 501 and the second brush 502.

For example, when the thickness of the coating material 900 cured on the first brush 501 becomes thinner, the controller 1100 may be configured to control the pressure applied by the first brush 501 to the substrate W to gradually increase during the process of cleaning the substrate W using the first brush 501. As another example, when the thickness of the coating material 900 cured on the first brush 501 is not uniform, the controller 1100 may be configured to control the pressure that each portion of the first brush 501 applies to the substrate W (e.g., applying a different pressure to the substrate W from different portions of the first brush 501). This may be equally applied to the second brush 502.

Referring to FIG. 17 and FIG. 18, in some embodiments, the substrate cleaning process may be stopped, and the first brush 501 and the second brush 502 may be removed from the third area P3. For example, when the first brush 501 and the second brush 502 are worn out during the substrate cleaning process, making it difficult to clean the substrate W, the substrate cleaning process may be stopped by the controller 1100.

When the substrate cleaning process is stopped, the controller 1100 may be configured to send a signal to control the motion of the first brush driver 401 and the second brush driver 402 to remove the first brush 501 and the second brush 502 from the third area P3. For example, when a command is received from the controller, the first brush 501 that was disposed in the third area P3 may be moved to the first area P1 by the first brush driver 401 and second brush 502 that was disposed in the third area P3 may be moved to the second area P2 by the second brush driver 402.

Referring to FIG. 19, in some embodiments, the coating material 900 may be provided to the first brush 501 and the second brush 502. The coating material 900 may be provided to the first brush 501 through the first nozzle 681, and the coating material 900 may be provided to the second brush 502 through the second nozzle 682. Unlike illustrated, in some embodiments, the coating material 900 may also be provided to only one of the first nozzle 681 and the second nozzle 682.

In some embodiments, a brush coating process may be performed in the first area P1 and the second area P2. In the first area P1, the brush coating process of the first brush 501 may be performed. In the second area P2, the brush coating process of the second brush 502 may be performed. Unlike illustrated, in some embodiments, the brush coating process may also be performed in only one of the first area P1 and the second area P2.

In some embodiments, the information M1 with respect to the coating material 900 cured on the first brush 501 measured by the first sensor 801 may be transmitted to the controller 1100. The information M2 with respect to the coating material 900 cured on the second brush 502 measured by the second sensor 802 may also be transmitted to the controller 1100.

In some embodiments, the controller 1100 may be configured to control factors such as the contact pressure between the first and second brushes 501 and 502 and the substrate W and the rotation speed of the first and second brushes 501 and 502 while the substrate cleaning process is performed in the third area P3 based on the information M1 and M2 received.

For example, when the thickness of the coating material 900 cured on the second brush 502 is less than the thickness of the coating material 900 cured on the first brush 501, the controller 1100 may be configured to control the second brush driver 402 to adjust the second brush 502 to be disposed closer to the substrate W.

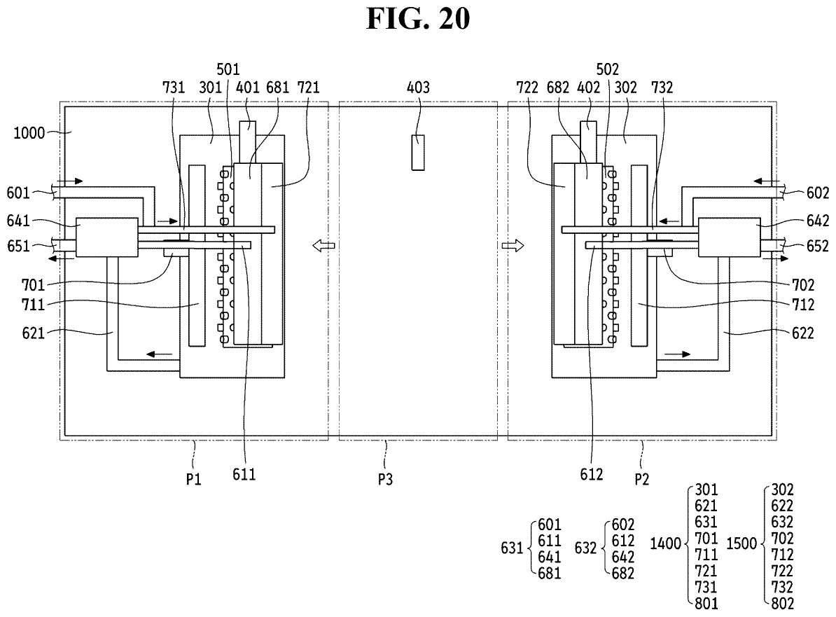

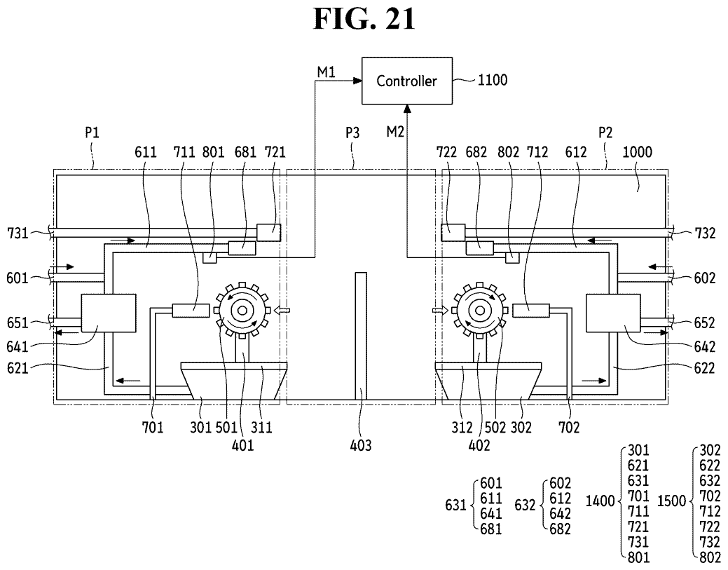

FIG. 20 is a plan view illustrating a substrate processing apparatus according to another embodiment of the present disclosure. FIG. 21 is a side view illustrating the substrate processing apparatus according to another embodiment of the present disclosure. For convenience of explanation, a first shutter 311 and a second shutter 312 is not shown in FIG. 20. For convenience of explanation, the description of FIG. 20 and FIG. 21 primarily is directed to the differences of the present disclosure from those previously described with reference to FIG. 17 to FIG. 19. For reference, FIG. 21 is a view illustrating an example embodiment in which, unlike FIG. 20, the first brush 501 and the second brush 502 move to the first area P1 and the second area P2, respectively.

Referring to FIG. 20 and FIG. 21, in some embodiments, a substrate processing apparatus according to another embodiment of the present disclosure may include a controller 1100 and a first area P1, a third area P3, and a second area P2 sequentially disposed within a chamber 1000.

In some embodiments, a first brush coating apparatus 1400 may be disposed in the first area P1 of the chamber 1000. In some embodiments, the first brush coating apparatus 1400 may include a first injector 631, a first thickness adjuster 711, a first thickness adjuster support 701, a first recovery tank 301, a first recovery pipe 621, a first sensor 801, a first catalyst supply nozzle 681, and a first catalyst supply pipe 731.

In some embodiments, a second brush coating apparatus 1500 may be disposed in the second area P2 of the chamber 1000. In some embodiments, the second brush coating apparatus 1500 may include a second injector 632, a second thickness adjuster 712, a second thickness adjuster support 702, a second recovery tank 302, a second recovery pipe 622, a second sensor 802, a second catalyst supply nozzle 681, and a second catalyst supply pipe 732.

In some embodiments, the first catalyst supply nozzle 681 may be disposed above the first recovery tank 301. After the coating material (see, e.g., coating material 900 in FIG. 19) is applied on the surface of the first brush 501, a catalyst may be provided on the surface of the first brush 501 by the first catalyst supply nozzle 681. The coating material 900 applied to the first brush 501 may be cured by a chemical reaction with the catalyst.

In some embodiments, the second catalyst supply nozzle 681 may be disposed above the second recovery tank 302. After the coating material 900 is applied on the surface of the second brush 502, a catalyst may be provided on the surface of the second brush 502 by the second catalyst supply nozzle 681. The coating material 900 applied to the second brush 502 may be cured by a chemical reaction with the catalyst.

In other words, in some embodiments, the coating material 900 provided to the first brush 501 and the second brush 502 may be cured by the catalyst rather than the curing devices (see, e.g., curing devices 661 and 662 in FIG. 17 to FIG. 19).

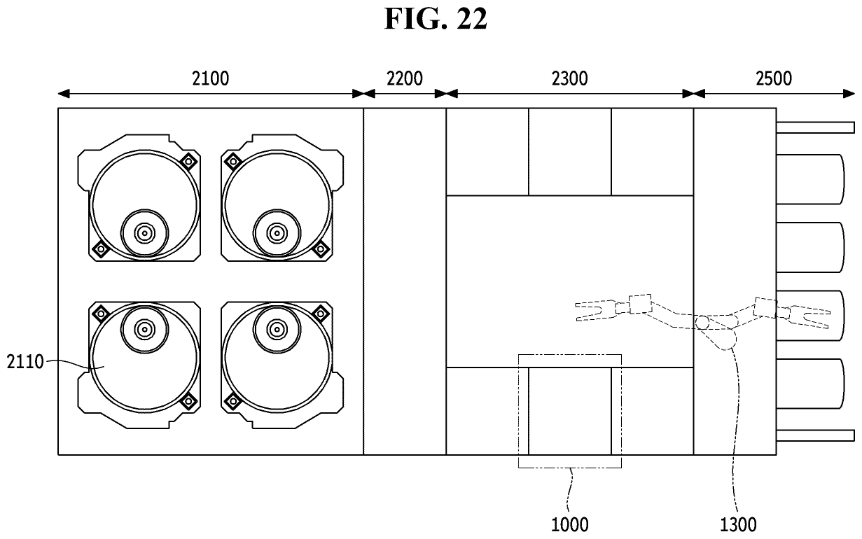

FIG. 22 is a schematic plan view illustrating a chemical mechanical polishing system according to another embodiment of the present disclosure. For convenience of explanation, the description of FIG. 22 primarily is directed to differences in the present disclosure from those previously described with reference to FIG. 14.

Referring to FIG. 22, in some embodiments, a chemical mechanical polishing system according to another embodiment of the present disclosure may include a polishing part 2100, a transport part 2200, a cleaning part 2300, and a cassette unit 2500.

In some embodiments, a substrate cleaning process and a brush coating process for removing organic substances and other foreign substances remaining on the surface of the substrate may be performed in the cleaning part 2300. For example, in some embodiments, both the substrate cleaning process and the brush coating process may be performed within the chamber 1000 of the cleaning part 2300. By performing the substrate cleaning process and the brush coating process in-situ within the cleaning part 2300, the process efficiency may be increased.

In some embodiments, the chamber 1000 of the cleaning part 2300 may correspond to the chamber 1000 o illustrated in FIG. 15. That is, in some embodiments, the chamber 1000 of the cleaning part 2300 may correspond to the chamber 1000 including the first area P1, the second area P2, and the third area P3 as illustrated in FIG. 15.

In concluding the detailed description, those skilled in the art will appreciate that many variations and modifications may be made to the example embodiments without substantially departing from the principles of the present disclosure. Therefore, the disclosed example embodiments of the present disclosure are used in a generic and descriptive sense only and not for purposes of limitation.

What is claimed is:

1. A substrate processing apparatus comprising:
a chamber;
a brush within the chamber;
a driver configured to rotate the brush;
an injector configured to inject a coating material onto a surface of the brush when the brush is rotated;
a thickness adjuster configured to adjust a thickness of the coating material on the surface of the brush when the brush is rotated; and
a curing device configured to cure the coating material having an adjusted thickness on the brush.

2. The substrate processing apparatus of claim 1, wherein the injector comprises a nozzle configured to inject the coating material,
the nozzle is positioned above the brush,
the thickness adjuster is positioned at the same height as the brush, and
the curing device is positioned below the brush.

3. The substrate processing apparatus of claim 1, wherein the thickness adjuster is positioned on one side of the brush, and
the brush is configured to contact the thickness adjuster in a downward direction, when the brush is rotated.

4. The substrate processing apparatus of claim 1, wherein the coating material comprises magnetic particles,
the brush comprises a first magnetic body having a first electrode,
the thickness adjuster comprises a second magnetic body having a second electrode different from the first electrode, and
the magnetic particles have an attractive force on the first magnetic body and a repulsive force on the second magnetic body.

5. The substrate processing apparatus of claim 1, further comprising a recovery tank positioned below the brush and configured to recover the coating material injected onto the brush.

6. The substrate processing apparatus of claim 5, wherein the recovery tank comprises a shutter,
the shutter is configured to open before the coating material is injected by the injector, and
the shutter is configured to be closed after the coating material is injected by the injector.

7. The substrate processing apparatus of claim 5, further comprising a purifier configured to purify the recovered coating material,
wherein the coating material purified by the purifier is configured to be re-supplied to the injector.

8. The substrate processing apparatus of claim 7, further comprising a contaminant discharge pipe connected to the purifier and configured to discharge filtered contaminants while the recovered coating material is allowed to pass through the purifier.

9. The substrate processing apparatus of claim 1, further comprising:
a sensor positioned on an upper portion of the brush and configured to measure a thickness of the coating material cured on the surface of the brush; and
a controller configured to receive information with respect to the thickness of the coating material measured by the sensor.

10. The substrate processing apparatus of claim 1, wherein the curing device is configured to cure the coating material by applying heat or light to the brush.

11. The substrate processing apparatus of claim 1, wherein the curing device is configured to cure the coating material by injecting a catalyst onto the brush.

12. A substrate processing apparatus comprising:
a chamber comprising a first area, a second area, and a third area, the second area residing between the first area and the third area;
a first brush within the chamber;
a first driver configured to rotate the first brush and move the first brush between the first area and the second area;
a second brush within the chamber;
a second driver configured to rotate the second brush and move the second brush between the second area and the third area;
a first brush coating apparatus residing in the first area, the first brush coating apparatus comprising:
a first injector configured to inject a first coating material onto a surface of the first brush when the first brush is rotated,
a first thickness adjuster configured to adjust a thickness of the coating material injected on the surface of the first brush when the first brush is rotated, and
a first curing device configured to cure the coating material with an adjusted thickness on the first brush;
a second brush coating apparatus residing in the third area, the second brush coating apparatus comprising:
a second injector configured to inject a second coating material onto a surface of the second brush when the second brush is rotated,
a second thickness adjuster configured to adjust a thickness of the second coating material on the second brush when the second brush is rotated, and
a second curing device configured to cure the second coating material with an adjusted thickness on the second brush; and
a controller configured to control the first driver, the second driver, the first brush coating apparatus, and the second brush coating apparatus.

13. The substrate processing apparatus of claim 12, wherein the controller is configured to control:
movement of the first brush and the second brush to the second area to clean a substrate,
movement of the first brush to the first area to apply the first coating material on the surface of the first brush, and
movement of the second brush to the third area to apply the second coating material on the surface of the second brush.

14. The substrate processing apparatus of claim 12, wherein the first brush coating apparatus further comprises a first sensor configured to measure a first thickness of the first coating material on the first brush,
the second brush coating apparatus further comprises a second sensor configured to measure a second thickness of the second coating material on the second brush, and
the controller is configured to receive information with respect to the first thickness and the second thickness of the coating material from the first sensor and the second sensor.

15. The substrate processing apparatus of claim 14, wherein the controller is configured to control a rotation speed and a pressure of the first driver and the second driver using the received information on the first thickness of the first coating material and the second thickness of the second coating material.

16. The substrate processing apparatus of claim 12, further comprising:
a first recovery tank positioned below the first brush in the first area and configured to recover the first coating material injected onto the first brush, and
a second recovery tank positioned below the second brush in the third area and configured to recover the second coating material injected onto the second brush.

17. The substrate processing apparatus of claim 16, wherein the first recovery tank comprises a first shutter,
the second recovery tank comprises a second shutter,
the first shutter is configured to be opened before the first coating material is injected by the first injector,
the first shutter is configured to be closed after the first coating material has been injected by the first injector,
the second shutter is configured to be opened before the second coating material is injected by the second injector, and
the second shutter is configured to be closed after the second coating material has been injected by the second injector.

18. The substrate processing apparatus of claim 16, further comprising:
a first purifier connected to the first recovery tank and configured to purify the first coating material recovered from the first recovery tank; and
a second purifier connected to the second recovery tank and configured to purify the second coating material recovered from the second recovery tank,
wherein the first coating material purified by the first purifier is configured to be re-supplied to the first injector, and
the second coating material purified by the second purifier is configured to be re-supplied to the second injector.

19. The substrate processing apparatus of claim 12, wherein the first curing device is configured to cure the first coating material by injecting a catalyst onto the first brush, and
the second curing device is configured to cure the second coating material by injecting a catalyst onto the second brush.

20. A substrate processing apparatus comprising:
a chamber;
a brush within the chamber;
a driver configured to rotate the brush;
an injector configured to inject a coating material onto a surface of the brush when the brush is rotated;
a thickness adjuster configured to adjust a thickness of the coating material on the surface of the brush when the brush is rotated;
a curing device configured to cure the coating material with an adjusted thickness on the brush;
a recovery tank positioned below the brush and configured to recover the coating material injected onto the brush;
a purifier connected to the recovery tank and configured to purify the recovered coating material;
a contaminant discharge pipe connected to the purifier and configured to discharge contaminants filtered from the recovered coating material to an outside of the chamber;
a supply pipe connected to the purifier and configured to re-supply the coating material purified by the purifier to the injector;
a sensor positioned on an upper portion of the brush and configured to measure a thickness of the coating material cured on the brush; and
a controller configured to receive information with respect to the thickness of the coating material from the sensor.
